(19) United States
(12) Patent Application Publication
(10) Pub. No.: US 2025/0332987 A1
(43) Pub. Date: Oct. 30, 2025

(54) METHODS AND APPARATUS FOR DETERMINING THE CURRENT LOAD PITCH ANGLE OF A VEHICLE AT A STANDSTILL FOR AUTOMATIC HEADLAMP RANGE ADJUSTMENT

(71) Applicant: Ford Global Technologies, LLC, Dearborn, MI (US)

(72) Inventors: Matthias Christian Reiter, Aachen (DE); Lars Michael Lottner, Odenthal (DE); Dietmar Koesters, Leverkusen (DE)

(21) Appl. No.: 19/190,262

(22) Filed: Apr. 25, 2025

(30) Foreign Application Priority Data
Apr. 29, 2024 (DE) 102024111964.0

(51) Int. Cl. B60Q 1/115; G06V 20/59

(52) U.S. Cl. CPC B60Q 1/115; G06V 20/59

(57) ABSTRACT

A method to determine a current load pitch angle of a vehicle for headlamp beam adjustment, the method determines a change in the current load pitch angle when the vehicle is at a standstill, captures at least one parameter indicating a change in a load of the vehicle, based on the captured at least one parameter indicating a change in the load of the vehicle, estimates a change in a load pitch angle of the vehicle, if the change in the current load pitch angle matches the estimated change in the load pitch angle of the vehicle, determines the current load pitch angle based on the change in the load pitch angle, and adjusts a headlamp of the vehicle based on the current load pitch angle.

### RELATED APPLICATION

This patent claims priority from DE Patent Application Number 102024111964.0, which was filed on Apr. 29, 2024, and is hereby incorporated herein by reference in its entirety.

### FIELD OF THE DISCLOSURE

The disclosure relates to a method for determining the current load pitch angle of a vehicle for automatic headlamp range adjustment of at least one headlamp of the vehicle. The disclosure also relates to a method and an apparatus for adjusting the headlamp range of at least one headlamp.

### BACKGROUND

A pitch angle of a vehicle can be determined using two mechanical height sensors, wherein a first height sensor is mounted on the front axle and a second height sensor is mounted on the rear axle. The height sensors provide information about a change in the suspension height, in which case an electrical output signal from the height sensor changes to influence a headlamp angle of the vehicle.

### SUMMARY

An example method for determining a current load pitch angle of a vehicle for headlamp beam adjustment includes determining a change in the current load pitch angle when the vehicle is at a standstill, capturing at least one parameter indicating a change in a load of the vehicle, based on the captured at least one parameter indicating a change in the load of the vehicle, estimating a change in a load pitch angle of the vehicle, if the change in the current load pitch angle matches the estimated change in the load pitch angle of the vehicle, determining the current load pitch angle based on the change in the load pitch angle, and adjusting a headlamp of the vehicle based on the current load pitch angle.

An example apparatus for adjusting a headlamp range of a vehicle includes machine-readable instructions, and programmable circuitry to execute the machine-readable instructions to capture at least one parameter indicating a change or possible change in a load of the vehicle, determine a change in a current load pitch angle when the vehicle is at a standstill, based on the captured at least one parameter indicating a change in the load of the vehicle, estimating a change in a load pitch angle of the vehicle, if the change in the current load pitch angle matches the estimated change in the load pitch angle of the vehicle, determine the current load pitch angle based on the change in the load pitch angle, and adjust the headlamp range based on the current load pitch angle.

An example non-transitory machine-readable storage medium includes instructions to cause programmable circuitry to at least capture at least one parameter indicating a change or possible change in a load of a vehicle, determine a change in a current load pitch angle when the vehicle is at a standstill, based on the captured at least one parameter indicating a change in the load of the vehicle, estimating a change in a load pitch angle of the vehicle, if the change in the current load pitch angle matches the estimated change in the load pitch angle of the vehicle, determine the current load pitch angle based on the change in the load pitch angle, and adjust a headlamp range of the vehicle based on the current load pitch angle.

### BRIEF DESCRIPTION OF DRAWINGS

FIG. 1 schematically shows an example method for determining the current load pitch angle of a vehicle in the form of a flowchart.

FIG. 2 schematically shows an example method for determining the current load pitch angle of a vehicle in the form of a flowchart.

FIG. 3 schematically shows an example method for headlamp range adjustment in the form of a flowchart.

FIG. 4 schematically shows an example vehicle with an example apparatus for headlamp range adjustment.

FIG. 5 is a block diagram of an example processing platform including programmable circuitry structured to execute, instantiate, and/or perform the example machine-readable instructions and/or perform the example operations of FIGS. 1-3.

In general, the same reference numbers will be used throughout the drawing(s) and accompanying written description to refer to the same or like parts. The figures are not necessarily to scale.

### DETAILED DESCRIPTION

Automatic headlamp range adjustment systems utilize a current load pitch angle of the vehicle in relation to the road as an essential input variable. A change in the load pitch angle can occur in particular as a result of loading or unloading of the vehicle, for example an automobile with a loaded trunk. When the load pitch angle changes, the headlamps can be readjusted, (e.g., corrected upward or downward with respect to their beam angle). For motor vehicles registered in the European Union (EU), automatic headlamp range adjustment systems are mandatory for certain types of headlamps.

The general term pitch angle is understood as meaning the current angle of the vehicle above the ground. This is rapidly variable and is influenced not only by the load of the vehicle, the vehicle longitudinal dynamics, in particular braking, acceleration, as well as going uphill and downhill due to additional power requirements, but also by random road bumps. In the present case, the factory condition, calibration condition, the condition of an unladen vehicle is defined as a condition with a pitch angle of zero degrees. All other angles describe a deviation from the factory condition or from the unladen condition.

An averaged pitch angle is understood as meaning the measurement angle of a system that determines an averaged pitch angle during the journey (e.g., a camera that determines a horizon angle via a series of images). The load pitch angle is understood as meaning the quasi-static portion of the pitch angle that depends only on the load, and not the driving situation. It corresponds to the angle that is set when at a standstill in the plane. The dynamic pitch angle is understood as meaning the current (e.g., the instantaneous, rapidly variable, etc.) deviation of the pitch angle from the load pitch angle (e.g., the part of the pitch angle which depends on the driving situation).

To determine the dynamic pitch angle, the longitudinal acceleration of the vehicle can be measured, which usually correlates with the dynamic pitch angle, because the dynamic pitch angle is mainly affected by acceleration forces that act on a predominantly linearly sprung system.

Currently, the pitch angle, including the load pitch angle of a vehicle, is typically determined with two mechanical height sensors, wherein a first height sensor is mounted on the front axle and a second height sensor is mounted on the rear axle. The height sensors provide information about a change in the suspension height, in which case an electrical output signal from the height sensor changes depending on the suspension height of the vehicle.

This signal can be utilized by a control unit (e.g., a headlamp control module (HCM)) to calculate the pitch angle and to control a stepper motor within the headlamp to adjust the latter. In combination with knowledge of the wheelbase, a direct, precise and fast method for determining the change in the pitch angle of a vehicle (e.g., due to an additional load or other factors) is available. There are also other variants that are based on one height sensor, typically on the rear axle.

However, said sensors are complex to integrate in existing vehicles. They are also maintenance-intensive, because they are directly exposed to environmental influences (e.g., the weather and mechanical influences caused by the road, stone chips, etc.). It is therefore desirable to replace the previously described solution based on mechanical sensors with alternatives. A combination of other available sensors is particularly useful in such examples. While it is possible to determine the load pitch angle using other sensors typically already present in a vehicle, such as acceleration sensors, it can be difficult to achieve the required accuracy which allows only small tolerances for lighting requirements.

Known methods can determine an averaged pitch angle with respect to the road via images captured by a front camera. The averaged pitch angle is typically determined during driving. Because the pitch angle of the vehicle can vary depending on the driving conditions (e.g., in connection with an ascent or descent) the average pitch angle determined via the camera also deviates from the pitch angle of the vehicle that occurs when the vehicle comes to a standstill in a horizontal plane (“load pitch angle”). However, a headlamp range adjustment system requires exactly this load pitch angle as an output variable. A load pitch angle can be reliably determined from an averaged pitch angle and other variables.

The documents DE 10 2017 005 019 A1, DE 10 2020 128 440 A1, DE 10 2011 017 697 A1, US 2021/0323466 A1 and US 2017/0225609 A1 describe methods and apparatuses for adjusting the headlamp range using a camera. In the document U.S. Pat. No. 10,953,787 B2, various sensors are used in connection with the headlamp range adjustment. Further prior art is disclosed in the documents EP 2 130 718 A2, CN 112477750 B, DE 10 2021 006290 A1, EP 0 709 240 A1, U.S. Pat. Nos. 6,693,380 B2, 6,450,673 B1, 6,193,398 B1, 9,260,051 B2, US 2016/0288698 A1, JP 5597472 B2, U.S. Pat. Nos. 10,676,016 B2 and 11,390,207 B2.

Because camera-based pitch angle determination is only possible when the vehicle is moving, it can be particularly challenging to determine the current load pitch angle of the vehicle in a relatively precise manner when the vehicle is at a standstill. In this context, it is useful to measure the gravitational angle (e.g., the angle between a longitudinal axis of the vehicle and the direction of the gravitational force) via a gravitational sensor. In this context, it is useful in the vehicle to represent the function of the gravitational sensor using the longitudinal acceleration sensor. Such a sensor is already installed in most vehicles (e.g., as part of an ABS or ESP system). In addition to a longitudinal acceleration, accelerations along other axes can also be additionally measured (e.g., lateral or vertical). Typical acceleration sensors react not only to the acceleration in relation to the environment, but also to the gravitational acceleration, essentially acceleration sensors measure only one component of the gravitational acceleration when at a standstill. The change in the gravitational angle (e.g., the angle between a longitudinal axis of the vehicle and the direction of the gravitational force) during loading and/or unloading of the vehicle can be used to estimate a change in the load condition of the vehicle. However, changes are only gradually captured here and there is the possibility of estimation errors increasing over time until the next absolute (e.g., not based on a series of incremental changes), for example camera-based, determination of the load pitch angle. In addition, barely controllable noise in the captured signal needs to be considered especially if the vehicle is moved (e.g., rolled away, pushed or towed away), while the electronic control unit (ECU) or the electronic controller of the vehicle is switched off.

Against this background, examples disclosed herein provide advantageous methods for determining the current load pitch angle of a vehicle for automatic headlamp range adjustment. Examples disclosed herein provide advantageous methods for headlamp range adjustment, an advantageous apparatus for headlamp range adjustment, vehicles, computer-implemented methods, computer program products, and computer-readable data carriers.

Examples disclosed herein provide methods for determining the current load pitch angle of a vehicle, methods for headlamp range adjustment, an apparatus for headlamp range adjustment, vehicles, computer-implemented methods, computer program products, and computer-readable data carriers.

Methods according to examples disclosed herein for determining (e.g., estimating) the current load pitch angle of a vehicle for automatic headlamp range adjustment of at least one headlamp (e.g., a front headlamp), of a vehicle relate to a vehicle which includes a device for estimating the change in the load pitch angle, that is to say is configured to use at least one method described herein for estimating (e.g., determining, measuring, etc.) a change in the pitch angle when the vehicle is at a standstill based on an acceleration sensor or gravitational sensor, and therefore indicating a change in the load pitch angle. The vehicle also includes at least one device for capturing (e.g., detecting) at least one parameter indicating a change in the load of the vehicle (e.g., a potential or possible change in the load of the vehicle).

An example method includes the following operations. When the vehicle comes to a standstill, a change in the current load pitch angle of the vehicle is estimated using an existing method. For example, the change in the pitch angle relative to gravity is determined (e.g. captured or measured) via the acceleration sensor during the period of time in which the vehicle is at a standstill, and a change in the load pitch angle is, thus, inferred. During the period in which the vehicle is at a standstill, at least one parameter indicating a change (e.g., a possible change) in the load of the vehicle is captured (e.g., detected, tracked). Based on the captured at least one parameter indicating a change (e.g., possible change) in the load condition of the vehicle, a change (e.g., a potential or possible change) in the load of the vehicle is estimated. If the estimated change (e.g., a potential or possible change) in the load pitch angle of the vehicle (e.g., the change estimated based on the captured at least one parameter indicating a change or possible change in the load condition of the vehicle) matches the change or possible change in the load pitch angle, determined via the device for estimating the change in the load pitch angle, that is to say determined via a described example method, within a defined error limit or deviation, the current load pitch angle is determined based on the change in the load pitch angle determined via the device for estimating the change in the load pitch angle.

In some examples, if the estimated change (e.g., the potential or possible change) in the load pitch angle of the vehicle does not match the change in the load pitch angle of the vehicle determined via the device for estimating the change in the load pitch angle, within the defined error limit or deviation, the load pitch angle determined via the device for estimating the change in the load pitch angle is rejected or reset. This has the advantage that only values that are expected to be determined in a substantially guaranteed manner are used to determine the current load pitch angle.

Example methods described herein have the advantage that the reliability of determining the current load pitch angle is improved. For example, a change in the load of the vehicle can be considered very quickly, efficiently and reliably when determining the current load pitch angle while the vehicle is at a standstill. Example methods described herein also have the advantage that a load pitch angle can be determined without using the height sensors described at the outset. Thus, in connection with a headlamp range adjustment, the use of height sensors may possibly be omitted in future.

In some examples, while the vehicle is moving, an averaged pitch angle of the vehicle can be determined via a device (e.g., a camera-based device) for determining an averaged pitch angle, and the current load pitch angle can be reliably determined based on the determined averaged pitch angle. Thus, when the vehicle is moving, the load pitch angle can be determined via a device for determining the load pitch angle during the journey of the vehicle. This has the advantage that, depending on whether the vehicle is moving or stationary, the method for determining the current load pitch angle that is more appropriate for the respective operating condition is used, thus increasing the accuracy and availability of the determination. In some examples, the device for determining (e.g., measuring or calculating) an averaged pitch angle of the vehicle includes at least one camera. The device for determining an averaged pitch angle may be an environment capture apparatus, for example, a camera. In some examples, the environment capture apparatus may be configured to capture the road ahead of the vehicle. Advantageously, the environment capture apparatus is configured to determine the current horizon line for determining an averaged pitch angle of the vehicle, that is to say for determining the deviation of the pitch angle from the factory condition or from the unladen condition.

In some examples, a parameter indicating a change or possible change in the load condition of the vehicle, a change in the operating condition (e.g., the opening and/or closing condition) of a window, a door, a tailgate, a hood cover, a cargo compartment, a seat belt, a trailer coupling, a parking brake, or a luggage compartment can be captured via a device (e.g., a camera) to determine a change in the load. If it is captured, for example, that the driver's door is being opened, it is possible that a person is leaving the vehicle or entering the vehicle. Therefore, a maximum change in the load of approximately 100 kg can be assumed. Because the driver's seat is usually centered near the middle of the wheelbase, only a limited change in the pitch angle of the vehicle can be assumed in such examples. Regarding a change in the opening condition of the other doors or the tailgate, a similar process can be carried out and a maximum, or possible, change in the load can be estimated. It can be assumed that the greatest change in the load pitch angle can be expected when opening the tailgate or rear door.

In some examples, a possible change in the load condition can be captured and tracked when the vehicle reaches a standstill. In some examples, a possible change in the load condition can be captured and tracked after a last reliable determination of the current load pitch angle (e.g., in a camera-based manner). Criteria or plausibility ranges for certain changes in the load condition of the vehicle can hereby be derived and used in connection with the determination of the current load pitch angle. If, for example, only the driver's door has been opened and closed within a relevant period, a change in the pitch angle of, for example, less than 0.1 degree can be assumed. Accordingly, it can be assumed that the current load pitch angle does not deviate by more than 0.1 degree from the current load pitch angle determined last (e.g., in a camera-based manner).

An example method for adjusting the headlamp range of at least one headlamp (e.g., a front headlamp), of a vehicle includes the following operations. First, a setting position of the at least one headlamp is determined. The prerequisite for this is an adjustment of the zero angle. Thus, with a nominal basic setting of a stepper motor angle, the headlamp is calibrated as part of installation in such a way that a defined light exit gradient is achieved. Normally, at the end of the production line, the headlamp is set to a “zero position” (on the control side). Because the headlamps as a component and the installation of the headlamps in the overall system contain large mechanical tolerances, the angle is then corrected via adjusting screws (or electronic control) such that the light exits at a fixed angle. This process is also referred to as “setting” or “aiming” and provides the setting position as a prerequisite for any further compensation. The subsequent headlamp range adjustment or leveling determines changes in the angle between the vehicle and the ground and compensates for the fixed light exit angle or the required deviation from the setting position.

After determining the setting position of the at least one headlamp, the current load pitch angle of the vehicle is determined via an example described above. In a next operation, the deviation of the current load pitch angle of the vehicle from the setting position, and thus the resulting deviation of the at least one headlamp from the setting position, is determined. A new target angle can be defined. The setting, of the light exit angle, of the at least one headlamp is then adjusted according to the deviation determined. For example, the defined new target angle can be controlled. The headlamp range can be adjusted by mechanically rotating a swivel frame by the required angle (e.g., in a manner controlled by a stepper motor). With high-resolution pixel headlamps, it is also possible to switch pixel rows on or off to avoid emitting light above the desired light-dark boundary. In other words, a change in the light exit angle is thus compensated for.

Example methods for headlamp range adjustment have the features and advantages already described in connection with the example methods described above for determining the current load pitch angle of the vehicle.

An example apparatus for adjusting the headlamp range of at least one headlamp of a vehicle relates to an apparatus or a vehicle which includes at least one device for estimating or determining the change in the load pitch angle of the vehicle when at a standstill (e.g., using a gravitational or acceleration sensor) and at least one device for capturing (e.g., detecting) at least one parameter indicating a change or possible change in the load of the vehicle.

The example apparatus for headlamp range adjustment is configured to receive data from the at least one device for estimating the change in the load pitch angle of the vehicle (e.g., at a standstill) and from the device for capturing (e.g., detecting) at least one parameter indicating a change or possible change in the load of the vehicle, and is configured to carry out a previously described example method for headlamp range adjustment. The example apparatus has the features and advantages already described in connection with the example methods described above.

In some examples, the device for capturing (e.g., detecting) at least one parameter indicating a change in the load of the vehicle can include at least one device (e.g., a camera) for capturing a passenger compartment, a luggage compartment, or at least one sensor for capturing the operating condition (e.g., the opening and/or closing condition0 of a seat belt, a window, a door, a tailgate, a hood cover, cargo compartment, a parking brake, or a trailer coupling of the vehicle. Other possible ways of capturing the passenger compartment are an ultrasonic sensor in an interior of the vehicle that detects the presence of cargo and/or persons, an interior microphone or seat mats with load detection, which are also used for restraint systems and belt monitoring, for example.

In some examples, an example apparatus for headlamp range adjustment may include at least one device for determining the load pitch angle during the journey, for example, a device (e.g., an environment capture apparatus, camera, etc.) for determining an averaged pitch angle, and may be configured to receive data relating to the vehicle and to carry out an example method described above. The device for determining an averaged pitch angle may be configured to capture the road ahead of the vehicle.

An example vehicle includes a previously described example apparatus for headlamp range adjustment. The example vehicle has the advantages already described. The vehicle can be an electric vehicle or a hybrid vehicle (HEV—hybrid electric vehicle). The vehicle may be a motor vehicle (e.g., an automobile, a truck, a bus, a minibus, a motorcycle, a moped, etc.).

An example computer-implemented method includes instructions which, when the program is executed by a computer, cause the latter to carry out an example method described above. An example computer program product includes instructions which, when the program is executed by a computer, cause the latter to carry out an example method described above. The computer program product is stored on a computer-readable data. The example computer-implemented method, the example computer program, and the example computer-readable data carrier have the features and advantages mentioned above.

The disclosure will be explained in more detail below on the basis of examples and with reference to the accompanying figures. Although the disclosure is illustrated and described more specifically in detail via examples, the disclosure is not restricted by the disclosed examples, and other variations may be derived therefrom by a person skilled in the art without departing from the scope of protection of the disclosure.

The figures are not necessarily accurate in all details and true to scale, and may be presented on an enlarged scale or a reduced scale to provide a better overview. Therefore, functional details disclosed here are to be understood not as being of a limiting nature but rather merely as an illustrative basis that provides a person skilled in the art in this technological field with guidance for using the present disclosure in a versatile manner.

The expression “and/or” used here, when used in a series of two or more elements, means that each of the stated elements may be used alone, or any combination of two or more of the stated elements may be used. For example, if a composition comprising the components A, B and/or C is described, the composition may comprise A on its own; B on its own; C on its own; A and B in combination; A and C in combination; B and C in combination; or A, B and C in combination.

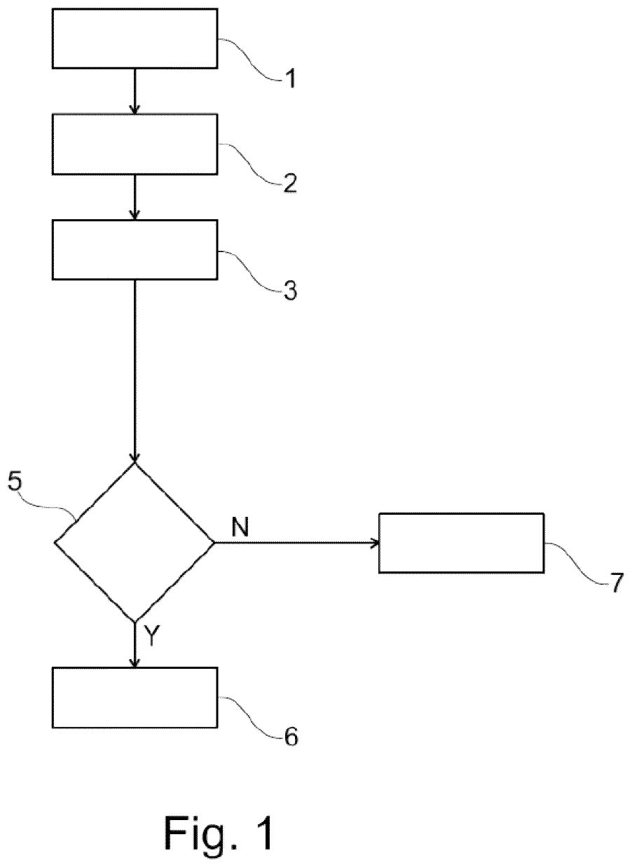

FIG. 1 schematically shows an example method for determining the current load pitch angle of a vehicle in the form of a flowchart. In operation 1, when the vehicle comes to a standstill, a change in the current load pitch angle is determined (e.g., captured or measured) via an example device for estimating the change in the load pitch angle during the period of time in which the vehicle is at a standstill. In operation 2, during the period of time in which the vehicle is at a standstill, at least one parameter indicating a change (e.g., a possible change) in the load of the vehicle is captured (e.g., detected) and the at least one parameter is tracked. Based on the captured at least one parameter indicating a change (e.g., a possible change) in the load condition of the vehicle, a change (e.g., a potential or possible change) in the load of the vehicle is estimated in operation 3. If the estimated change (e.g., a potential or possible change) in the load pitch angle of the vehicle matches the change in the load pitch angle, determined via the device for estimating the change in the load pitch angle, within a defined error limit or deviation, which is checked in operation 5, the current load pitch angle is determined in operation 6 based on the change in the current load pitch angle captured via the device for estimating the change in the load pitch angle. In operation 7, if the estimated possible change in the load pitch angle of the vehicle does not match the change in the load pitch angle (e.g., determined via the device for estimating the change in the load pitch angle) within the defined error limit or deviation, the determined current load pitch angle is rejected or reset based on the change in the load pitch angle estimated via the device for estimating the change in the load pitch angle.

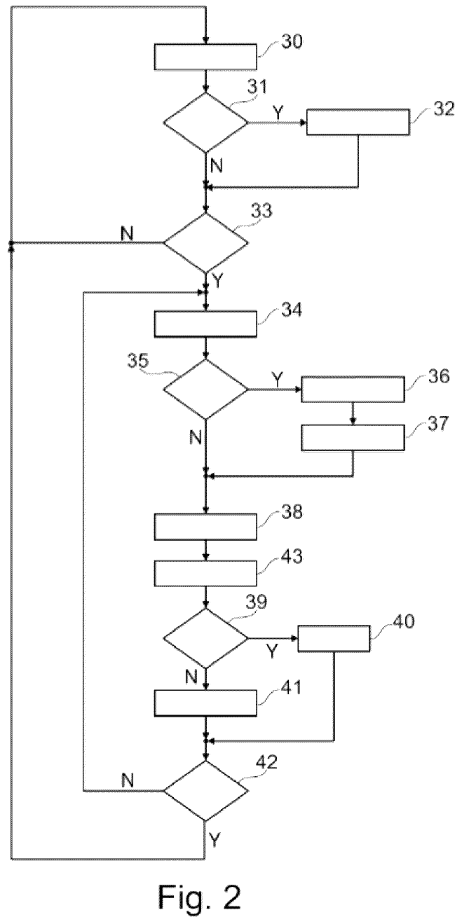

FIG. 2 schematically shows an example method for determining the current load pitch angle of a vehicle in the form of a flowchart. In operation 30, the vehicle moves. Example operation 31 corresponds to checking whether values (e.g., absolute measured values) of the current load pitch angle are available or received (e.g., in a camera-based manner). If this is the case, data tracked in operation 32 are reset based on a potential change in the load of the vehicle in the period because the last absolute value of the load pitch angle was received. If the vehicle has not come to a standstill, which is checked in operation 33, the process restarts. As soon as the vehicle comes to a standstill, the tracking of data related to a potential change in the load of the vehicle in the current standstill phase begins in operation 34; any data that possibly still exist from a previous standstill phase are reset.

Operation 35 corresponds to checking whether at least one parameter indicating a change or possible change in the load of the vehicle has been detected in the time because the vehicle came to a standstill. If this is the case, this parameter detection is tracked both in terms of the period because the last absolute measured value of the load pitch angle was received and in terms of the period of the current standstill phase. This takes place in operations 36 and 37.

In operation 38, an intermediate result for a change in the load pitch angle of the vehicle is determined (e.g., calculated) using an already existing method (e.g., based on measurements via a gravitational sensor). In operation 43, a possible or plausible change in the load pitch angle is estimated on the basis of the tracked detections of the parameters, which indicate a possible load change because the beginning of the current standstill phase, and the tracked detections of the parameters, which indicate a possible load change because receipt of the last absolute measured value of the load pitch angle. Operation 39 corresponds to checking whether the result from operation 38 corresponds to the possible or plausible load change determined (e.g., calculated) in operation 43.

If both values match within a defined deviation interval or error interval, or if the values compared with one another in operation 39 correspond, the current load pitch angle is updated in operation 40. If the criterion from operation 39 is not met, that is to say the change in the pitch angle determined in operation 38 does not correspond to the possible or plausible change in the load pitch angle determined in operation 43 and derived from a potential change in the load, the change in the load pitch angle determined in operation 38 is rejected or reset in operation 41. Following operation 40 or 41, operation 42 corresponds to checking whether the vehicle has started. If this is the case, the method transitions to operation 30. Otherwise, that is to say if the vehicle is still at a standstill at operation 42, the method transitions to operation 35.

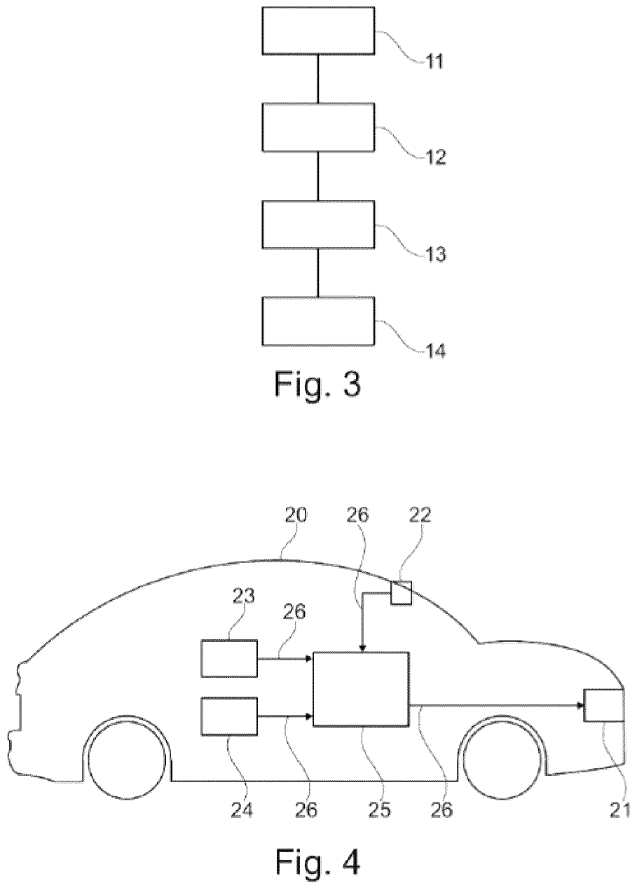

FIG. 3 schematically shows an example method for headlight range adjustment in the form of a flowchart. In operation 11, a setting position of the at least one headlamp is determined to control the headlamp range. The prerequisite for this is an adjustment of the zero angle. Thus, with a nominal basic setting of a stepper motor angle, the headlamp is calibrated as part of installation in such a way that a defined light exit gradient is achieved. This means that the headlamp is mechanically and/or optically calibrated (headlamp setting). A zero angle can be commanded to the headlamp range setting, which is then also approached by the latter. At the same time, the corresponding load pitch angle (e.g., reference load angle, zero load angle) can be determined (e.g., in a reference station with known targets).

In operation 12, the current load pitch angle of the vehicle (e.g., relative to the zero load angle or to the setting position) determined in operation 11, is determined, for example via an example method explained based on FIGS. 1-2. In operation 13, the deviation of the current load pitch angle from the setting position and, thus, the resulting deviation of the headlamp from the setting position, is determined based on the determined current load pitch angle of the vehicle. In this context, a new target angle can be defined. Then, in operation 14, the setting (e.g., the light exit angle of the at least one headlamp) is adjusted according to the determined deviation (e.g., the defined new target angle is headed for).

Example instructions and/or operations of FIGS. 1-3 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 4 schematically shows an example vehicle 20 with an example apparatus 25 for headlamp range adjustment. The motor vehicle 20 includes at least one headlamp 21 (e.g., a front headlamp) and at least one device for estimating the change in the load pitch angle 24 (e.g., a gravitational sensor). Furthermore, the vehicle 20 or the apparatus 25 for headlamp range adjustment includes a device 23 for capturing at least one parameter indicating a change or possible change in the load of the vehicle 20. In some examples, the vehicle 20 or the apparatus 25 for headlamp range adjustment may include a device 22 for determining a load pitch angle during the journey (e.g., an environment capture apparatus, a camera) for determining an averaged pitch angle of the vehicle, which may be mounted, for example on a windshield of the vehicle 20.

The apparatus 25 for headlamp range adjustment is configured to receive data from the device 24 for estimating the change in the load pitch angle and data from the device 23 for capturing at least one parameter indicating a change or possible change in the load of the vehicle 20, as well as data from the device 22 for determining a load pitch angle during the journey, and to carry out an example method for headlamp range adjustment, for example a method described with reference to FIGS. 1 and 2. The data transmission is indicated in FIG. 4 in each case by arrows with the reference number 26. For setting (e.g., controlling or adjusting) the headlamp range of the headlamp 21, the apparatus 25 for headlamp range adjustment transmits corresponding data to a control unit, for example, for controlling a stepper motor within the headlamp 21.

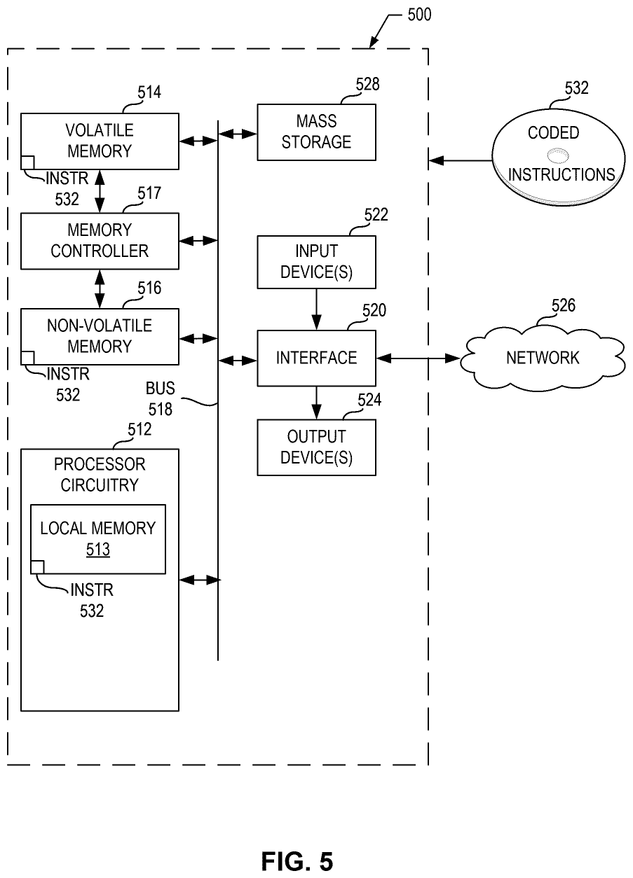

FIG. 5 is a block diagram of an example programmable circuitry platform 500 structured to execute and/or instantiate the example machine-readable instructions and/or the example operations of FIGS. 1-3 to implement examples disclosed herein. The programmable circuitry platform 500 can be, for example, a control device, an electronic control unit (ECU), a self-learning machine (e.g., a neural network), or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 512 may be implemented by one or more semiconductor based (e.g., silicon based) devices.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a button, a touchscreen, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 532, which may be implemented by the machine-readable instructions of FIG. [Flowcharts], may be stored in the mass storage device 528, in the volatile memory 514, in the non-volatile memory 516, and/or on at least one non-transitory computer readable storage medium such as a CD or DVD which may be removable.

Example methods, apparatus, systems, and articles of manufacture to enable determining the current load pitch angle of a vehicle at a standstill for automatic headlamp range adjustment are disclosed herein. Further examples and combinations thereof include the following:

Example 1 includes a method for determining a current load pitch angle of a vehicle for headlamp beam adjustment, the method comprising determining a change in the current load pitch angle when the vehicle is at a standstill, capturing at least one parameter indicating a change in a load of the vehicle, based on the captured at least one parameter indicating a change in the load of the vehicle, estimating a change in a load pitch angle of the vehicle, if the change in the current load pitch angle matches the estimated change in the load pitch angle of the vehicle, determining the current load pitch angle based on the change in the load pitch angle, and adjusting a headlamp of the vehicle based on the current load pitch angle.

Example 2 includes the method of example 1, wherein if the change in the load pitch angle of the vehicle does not match the estimated change in the load pitch angle within a defined error limit, the current load pitch angle is rejected or reset.

Example 3 includes the method of example 1, wherein a parameter indicating a change in the load of the vehicle includes a change in an operating condition of a window, a door, a tailgate, or a hood of the vehicle.

Example 4 includes the method of example 1, wherein a parameter indicating a change in the load of the vehicle includes a change in an operating condition of a cargo compartment of the vehicle.

Example 5 includes the method of example 4, wherein the at least one parameter indicating the change in the load of the vehicle is captured by a camera to detect a presence of cargo in the cargo compartment of the vehicle.

Example 6 includes the method of example 1, wherein a parameter indicating a change in the load of the vehicle includes a change in an operating condition of a seatbelt of the vehicle.

Example 7 includes the method of example 1, wherein a parameter indicating a change in the load of the vehicle includes a change in an operating condition of a parking brake or a trailer coupling of the vehicle.

Example 8 includes an apparatus for adjusting a headlamp range of a vehicle, the apparatus comprising machine-readable instructions, and programmable circuitry to execute the machine-readable instructions to capture at least one parameter indicating a change or possible change in a load of the vehicle, determine a change in a current load pitch angle when the vehicle is at a standstill, based on the captured at least one parameter indicating a change in the load of the vehicle, estimating a change in a load pitch angle of the vehicle, if the change in the current load pitch angle matches the estimated change in the load pitch angle of the vehicle, determine the current load pitch angle based on the change in the load pitch angle, and adjust the headlamp range based on the current load pitch angle.

Example 9 includes the apparatus of example 8, wherein the at least one parameter indicating a change in the load of the vehicle includes an operating condition of a window, a door, a tailgate, or a hood cover of the vehicle.

Example 10 includes the apparatus of example 8, wherein a parameter indicating a change in the load of the vehicle includes a change in an operating condition of a cargo compartment of the vehicle.

Example 11 includes the apparatus of example 10, wherein capturing the at least one parameter indicating the change in the load of the vehicle includes a camera to detect a presence of cargo in the cargo compartment of the vehicle.

Example 12 includes the apparatus of example 8, wherein a parameter indicating a change in the load of the vehicle includes a change in an operating condition of a seatbelt of the vehicle.

Example 13 includes the apparatus of example 8, wherein a parameter indicating a change in the load of the vehicle includes a change in an operating condition of a parking brake or a trailer coupling of the vehicle.

Example 14 includes a non-transitory machine-readable storage medium comprising instructions to cause programmable circuitry to at least capture at least one parameter indicating a change or possible change in a load of a vehicle, determine a change in a current load pitch angle when the vehicle is at a standstill, based on the captured at least one parameter indicating a change in the load of the vehicle, estimating a change in a load pitch angle of the vehicle, if the change in the current load pitch angle matches the estimated change in the load pitch angle of the vehicle, determine the current load pitch angle based on the change in the load pitch angle, and adjust a headlamp range of the vehicle based on the current load pitch angle.

Example 15 includes the non-transitory machine-readable storage medium of example 14, wherein the instructions cause the programmable circuitry to if the change in the load pitch angle of the vehicle does not match the estimated change in the load pitch angle within a defined error limit/deviation, the current load pitch angle is rejected or reset.

Example 16 includes the non-transitory machine-readable storage medium of example 14, wherein a parameter indicating a change in the load of the vehicle includes a change in an operating condition of a window, a door, a tailgate, or a hood of the vehicle.

Example 17 includes the non-transitory machine-readable storage medium of example 14, wherein a parameter indicating a change in the load of the vehicle includes a change in an operating condition of a cargo compartment of the vehicle.

Example 18 includes the non-transitory machine-readable storage medium of example 17, wherein capturing the at least one parameter indicating the change in the load of the vehicle includes a camera to detect a presence of cargo in the cargo compartment of the vehicle.

Example 19 includes the non-transitory machine-readable storage medium of example 14, wherein a parameter indicating a change in the load of the vehicle includes a change in an operating condition of a seatbelt of the vehicle.

Example 20 includes the non-transitory machine-readable storage medium of example 14, wherein a parameter indicating a change in the load of the vehicle includes a change in an operating condition of a parking brake or a trailer coupling of the vehicle.

What is claimed is:

1. A method for determining a current load pitch angle of a vehicle for headlamp beam adjustment, the method comprising:
determining a change in the current load pitch angle when the vehicle is at a standstill;
capturing at least one parameter indicating a change in a load of the vehicle;
based on the captured at least one parameter indicating a change in the load of the vehicle, estimating a change in a load pitch angle of the vehicle;
if the change in the current load pitch angle matches the estimated change in the load pitch angle of the vehicle, determining the current load pitch angle based on the change in the load pitch angle; and
adjusting a headlamp of the vehicle based on the current load pitch angle.

2. The method of claim 1, wherein if the change in the load pitch angle of the vehicle does not match the estimated change in the load pitch angle within a defined error limit, the current load pitch angle is rejected or reset.

3. The method of claim 1, wherein a parameter indicating a change in the load of the vehicle includes a change in an operating condition of at least one of a window, a door, a tailgate, or a hood of the vehicle.

4. The method of claim 1, wherein a parameter indicating a change in the load of the vehicle includes a change in an operating condition of a cargo compartment of the vehicle.

5. The method of claim 4, wherein the at least one parameter indicating the change in the load of the vehicle is captured by a camera to detect a presence of cargo in the cargo compartment of the vehicle.

6. The method of claim 1, wherein a parameter indicating a change in the load of the vehicle includes a change in an operating condition of a seatbelt of the vehicle.

7. The method of claim 1, wherein a parameter indicating a change in the load of the vehicle includes a change in an operating condition of a parking brake or a trailer coupling of the vehicle.

8. An apparatus for adjusting a headlamp range of a vehicle, the apparatus comprising:
machine-readable instructions; and
programmable circuitry to execute the machine-readable instructions to:
capture at least one parameter indicating a change or possible change in a load of the vehicle;
determine a change in a current load pitch angle when the vehicle is at a standstill;
based on the captured at least one parameter indicating a change in the load of the vehicle, estimating a change in a load pitch angle of the vehicle;
if the change in the current load pitch angle matches the estimated change in the load pitch angle of the vehicle, determine the current load pitch angle based on the change in the load pitch angle; and
adjust the headlamp range based on the current load pitch angle.

9. The apparatus of claim 8, wherein the at least one parameter indicating a change in the load of the vehicle includes an operating condition of at least one of a window, a door, a tailgate, or a hood cover of the vehicle.

10. The apparatus of claim 8, wherein a parameter indicating a change in the load of the vehicle includes a change in an operating condition of a cargo compartment of the vehicle.

11. The apparatus of claim 10, wherein capturing the at least one parameter indicating the change in the load of the vehicle includes a camera to detect a presence of cargo in the cargo compartment of the vehicle.

12. The apparatus of claim 8, wherein a parameter indicating a change in the load of the vehicle includes a change in an operating condition of a seatbelt of the vehicle.

13. The apparatus of claim 8, wherein a parameter indicating a change in the load of the vehicle includes a change in an operating condition of a parking brake or a trailer coupling of the vehicle.

14. A non-transitory machine-readable storage medium comprising instructions to cause programmable circuitry to at least:
capture at least one parameter indicating a change or possible change in a load of a vehicle;
determine a change in a current load pitch angle when the vehicle is at a standstill;
based on the captured at least one parameter indicating a change in the load of the vehicle, estimating a change in a load pitch angle of the vehicle;
if the change in the current load pitch angle matches the estimated change in the load pitch angle of the vehicle, determine the current load pitch angle based on the change in the load pitch angle; and
cause adjustment of a headlamp range of the vehicle based on the current load pitch angle.

15. The non-transitory machine-readable storage medium of claim 14, wherein the instructions cause the programmable circuitry to:
if the change in the load pitch angle of the vehicle does not match the estimated change in the load pitch angle within a defined error limit/deviation, reject or reset the current load pitch angle.

16. The non-transitory machine-readable storage medium of claim 14, wherein a parameter indicating a change in the load of the vehicle includes a change in an operating condition of at least one of a window, a door, a tailgate, or a hood of the vehicle.

17. The non-transitory machine-readable storage medium of claim 14, wherein a parameter indicating a change in the load of the vehicle includes a change in an operating condition of a cargo compartment of the vehicle.

18. The non-transitory machine-readable storage medium of claim 17, wherein capturing the at least one parameter indicating the change in the load of the vehicle includes a camera to detect a presence of cargo in the cargo compartment of the vehicle.

19. The non-transitory machine-readable storage medium of claim 14, wherein a parameter indicating a change in the load of the vehicle includes a change in an operating condition of a seatbelt of the vehicle.

20. The non-transitory machine-readable storage medium of claim 14, wherein a parameter indicating a change in the load of the vehicle includes a change in an operating condition of a parking brake or a trailer coupling of the vehicle.
